(19) United States
(12) Patent Application Publication
(10) Pub. No.: US 2015/0001885 A1
(43) Pub. Date: Jan. 1, 2015

(54) MIXED MATERIAL UNDERBODY FOR NOISE CONTROLLED OCCUPANT COMPARTMENT

(71) Applicant: GM Global Technology Operations LLC, Detroit, MI (US)

(72) Inventors: Robert N. SAJE, Shelby Township, MI (US); Artur WYSZYNSKI, Oxford, MI (US); Terry A. SWARTZELL, Ann Arbor, MI (US); John C. JOHNSON, Macomb Township, MI (US); Peter M. PARLOW, Columbus, MI (US); Chad CROMWELL, Lake Orion, MI (US)

(21) Appl. No.: 13/931,170

(22) Filed: Jun. 28, 2013

(51) Int. Cl. B60R 13/08

(52) U.S. Cl. CPC B60R 13/0815
USPC 296/193.07; 156/92; 29/428

(57) ABSTRACT

A product comprising a mixed material vehicle underbody which may reduce or prevent noise from entering into the occupant compartment of a vehicle and a method for making the same.

### TECHNICAL FIELD

The field to which the disclosure generally relates to includes automotive vehicles.

### BACKGROUND

An automotive vehicle may include an occupant compartment.

### SUMMARY OF ILLUSTRATIVE VARIATIONS

One variation may include a product comprising: a vehicle underbody; wherein the vehicle underbody comprises at least one steel panel; and wherein the at least one steel panel is attached to a plurality of structures comprising aluminum.

Another variation may include a method comprising: forming a mixed material underbody to create a noise barrier to reduce or eliminate noise entering into an occupant compartment of a vehicle comprising attaching at least one steel panel to a plurality of structures comprising aluminum.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an underbody of a vehicle according to a number of variations of the invention.

FIG. 2 depicts an assembly including a steel panel, adhesive layer, and aluminum layer having a self-pierce rivet extending therethrough.

FIG. 3 depicts an assembly including a steel panel pinned by a flow drill screw to an extrusion comprising aluminum.

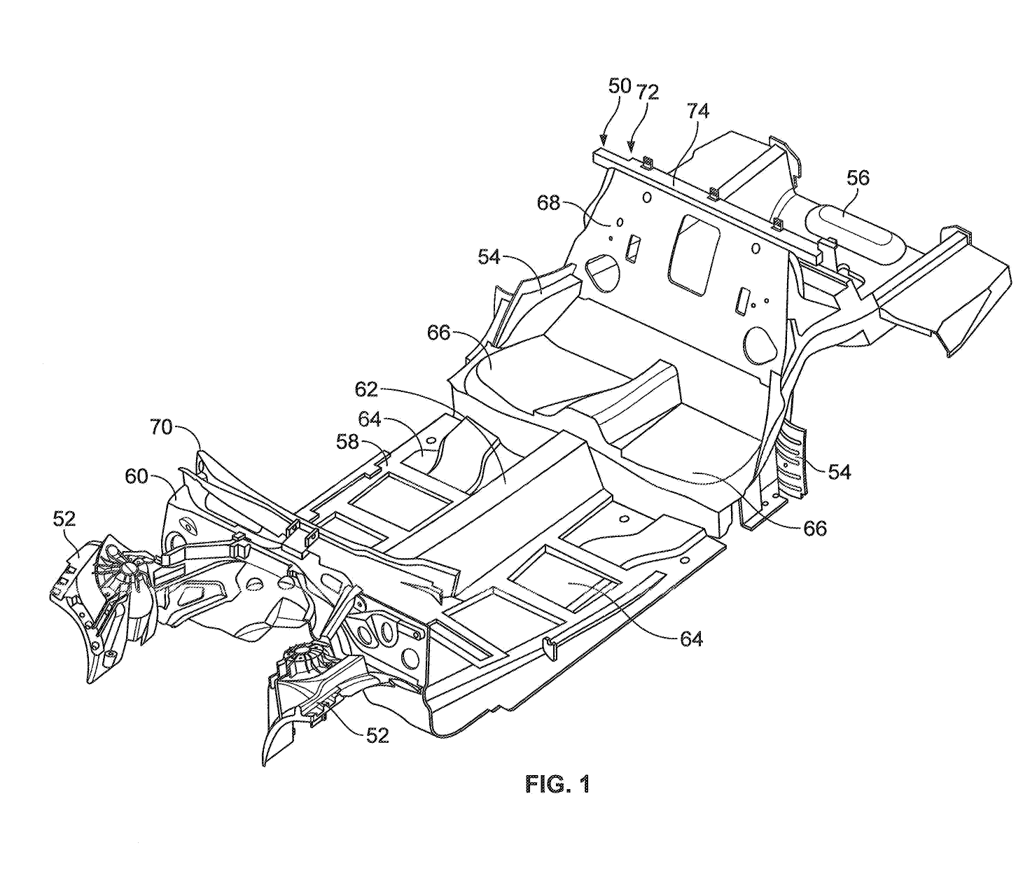

### DETAILED DESCRIPTION OF ILLUSTRATIVE VARIATIONS

The following description of the variations is merely illustrative in nature and is in no way intended to limit the scope o the invention, its application, or uses.

In one variation, a vehicle body structure may include a mixed material underbody which may reduce or prevent noise from entering into the occupant compartment of a vehicle.

Another variation may include a method for reducing or preventing noise from entering into the occupant compartment of a vehicle through the use of a mixed material underbody.

A vehicle may include an underbody structure 50 which may be seated underneath an occupant compartment. Sounds from within the vehicle and/or sounds from the exterior of the vehicle may enter the occupant compartment which may disturb passengers seated inside the vehicle. In order to eliminate or reduce noise entering into the occupant compartment, the underbody structure 50 may act as a noise barrier to prevent or reduce noise from entering into the occupant compartment.

Referring to FIG, 1, in one variation, an underbody 50 may include one or more steel panels 58 which may be attached to a plurality of structures comprising aluminum 52, 54, 56, such as aluminum based alloys. The structures may include, but are not limited to, the front rear rails (not shown), the front wheelhouse 52, the rockers (not shown), the rear rails 54, the rear wheelhouse sub-assemblies (not shown), or the rear tire tub 56. The one or more steel panels 58 may include any variety of structures including, but not limited to, the primary dash 60, the plenum 70, the tunnel 62, the floor 64, the seat pan 66, and the back panels 68. The one or more steel panels 58 may be attached to the plurality of structures comprising aluminum 52, 54, 56 to close out the occupant compartment. The one or more steel panels 58 may be attached to the plurality of structures comprising aluminum 52, 54, 56, in any of a number of variations including, but not limited to. flow drill screws, self-piercing rivets, or spot and mig welding and the use of a structural adhesive.

The use of the one or more structures comprising aluminum 52, 54, 56 and the one or more steel panels 58 in the underbody 50 may allow for a more efficient noise barrier while reducing the mass of the underbody 50. For example, steel may act as a more efficient noise barrier than aluminum as steel has higher density properties than aluminum. The use of the steel panels 58 and the aluminum panels 52, 54, 56 may reduce the weight of a vehicle underbody 50 as compared to an underbody comprised entirely of steel as aluminum may have a lower weight than steel. Further, the use of the steel panels 58 and the aluminum panels 52, 54, 56 may have a lower mass than an aluminum underbody as an aluminum underbody may require at least one supplemental acoustic barrier in order to meet the noise barrier performance of steel, which may substantially increase the mass of the underbody 50.

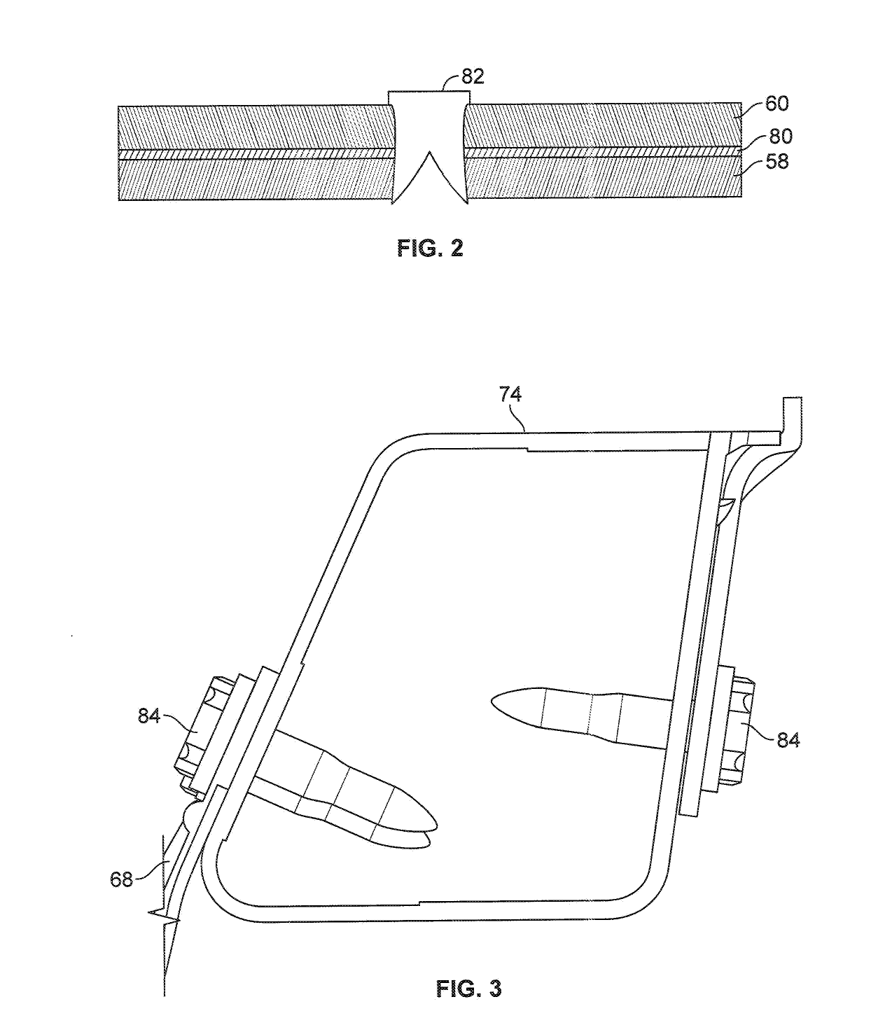

FIG. 2 illustrates a number of variations which may include an assembly including a steel panel 60 bonded by an adhesive layer 80 to a layer comprising aluminum 60 with a self-piercing rivet 82 extending through the layers 60, 80 and 58.

FIG. 3 illustrates a number of variations which may include an extrusion 74 comprising aluminum, such as a seat back beam, which may have a steel seat back panel 68 attached thereto by a flow drill screw 84. The section profile of the extrusion may be thicker in the areas where a flow drill screw 84 may be used.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a vehicle underbody; wherein the vehicle underbody comprises at least one steel panel; and wherein the at least one steel panel is attached to a plurality of structures comprising aluminum.

Variation 2 may include a product as set forth in Variation 1 wherein the at least one steel panel comprises a primary dash, a plenum, a tunnel, a floor, a seat pan, and at least one back panel.

Variation 3 may include a product as set forth in any of

Variations 1-2 wherein the plurality of structures comprising aluminum include a pair of front rails, a pair of front wheelhouse structures, a pair of rockers, a pair of rear rails, a plurality of rear wheelhouse sub-assemblies, or a rear tire tub.

Variation 4 may include a product as set forth in any of

Variations 1-3 wherein the at least one steel panel is attached to the plurality of structures comprising aluminum via a plurality of flow drill screws.

Variation 5 may include a product as set forth in any of

Variations 1-3 wherein the at least one steel panel is attached to the plurality of structures comprising aluminum via a plurality of self-piercing rivets.

Variation 6 may include a product as set forth in any of

Variations 1-5 wherein the underbody is constructed and arranged to attach to a vehicle body.

Variation 7 may include a product as sot forth in any of

Variations 1-6 wherein the underbody is constructed and arranged to provide a noise barrier for an occupant compartment of a vehicle.

Variation 8 may include a method comprising: forming a mixed material underbody to create a noise barrier to reduce or eliminate noise entering into an occupant compartment of a vehicle comprising attaching at least one steel panel to a plurality of structures comprising aluminum.

Variation 9 may include a method as set forth in Variation 8 wherein the at least one steel panel comprises a primary dash, a plenum, a tunnel, a floor, a seat pan, and at least one back panel.

Variation 10 may include a method as set forth in any of

Variations 8-9 wherein the plurality of structures comprising aluminum includes a pair of wheel house structures, a pair of rear rails, and a rear tire tub.

Variation 11 may include a method as set forth in any of

Variations 8-10 wherein the at least one steel panel is attached to the plurality of structures comprising aluminum via a structural adhesive and a plurality of flow drill screws.

Variation 12 may include a method as set forth in any of

Variations 8-10 wherein the at least one steel panel is attached to the plurality of structures comprising aluminum via a plurality of self-piercing rivets.

Variation 13 may include a method as set forth in any of

Variations 8-12 wherein the underbody is constructed and arranged to attach to a vehicle body.

Variation 14 may include a method as set forth in any of

Variations 8-13 wherein the underbody is constructed and arranged to provide a noise barrier for an occupant compartment of a vehicle.

The above description of select examples of the invention is merely illustrative in nature and, thus, variations or variants thereof are not to be regarded as a departure from the spirit and scope of the invention.

What is claimed is:

1. A product comprising:
a vehicle underbody;
wherein the vehicle underbody comprises at least one steel panel; and
wherein the at least one steel panel is attached to a plurality of structures comprising aluminum.

2. The product of claim 1 wherein the at least one steel panel comprises a primary dash, a plenum, a tunnel, a floor, a seat pan, and at least one back panel.

3. The product of claim 1 wherein the plurality of structures comprising aluminum includes a pair of front rails, a pair of front wheelhouse structures, a pair of rockers, a pair of rear rails, a plurality of rear wheelhouse sub-assemblies, or a rear tire tub 56.

4. The product of claim 1 wherein the at least one steel panel is attached to the plurality of structures comprising aluminum via a plurality of flow drill screws.

5. The product of claim 1 wherein the at least one steel panel is attached to the plurality of structures comprising aluminum via a plurality of self-piercing rivets.

6. The product of claim 1 wherein the underbody is constructed and arranged to attach to a vehicle body.

7. The product of claim 1 wherein the underbody is constructed and arranged to provide a noise barrier for an occupant compartment of a vehicle.

8. A method comprising:
forming a mixed material underbody to create a noise barrier to reduce or eliminate noise entering into an occupant compartment of a vehicle comprising attaching at least one steel panel to a plurality of structures comprising aluminum.

9. The method of claim 8 wherein the at least one steel panel comprises a primary dash, a plenum, a tunnel, a floor, a seat pan, and at least one back panel.

10. The method of claim 8 wherein the plurality of structures comprising aluminum includes a pair of wheelhouse structures, a pair of rear rails, and a rear tire tub.

11. The method of claim 8 wherein the at least one steel panel is attached to the plurality of structures comprising aluminum via a plurality of flow drill screws.

12. The method of claim 8 wherein the at least one steel panel is attached to the plurality of structures comprising aluminum via a structural adhesive and a plurality of self-piercing rivets.

13. The method of claim 8 wherein the underbody is constructed and arranged to attach to a vehicle body.

14. The method of claim 8 wherein the underbody is constructed and arranged to provide a noise barrier for an occupant compartment of a vehicle.
